(19) United States
(12) Patent Application Publication
(10) Pub. No.: US 2025/0178330 A1
(43) Pub. Date: Jun. 5, 2025

(54) ASSEMBLY APPARATUS AND METHOD FOR ASSEMBLING ELECTRONIC DEVICE

(71) Applicant: Wistron Corp., New Taipei City (TW)

(72) Inventors: Ze Shan YAN, New Taipei City (TW); Shun Chi YEH, New Taipei City (TW); Fu Hua YAN, New Taipei City (TW); Xiao Mei ZHANG, New Taipei City (TW)

(21) Appl. No.: 18/433,663

(22) Filed: Feb. 6, 2024

(30) Foreign Application Priority Data
Nov. 30, 2023 (CN) 202311628995.1

(51) Int. Cl. B32B 37/00; B08B 5/02; B08B 5/04; B32B 37/18; B32B 38/16; B32B 41/00

(52) U.S. Cl. CPC B32B 37/0046; B08B 5/02; B08B 5/04; B32B 37/18; B32B 38/162; B32B 41/00; B32B 2457/00

(57) ABSTRACT

An assembly apparatus is provided, and includes an operating platform, a supply module, an assembly module and a robotic arm. The operating platform is used to carry an electronic device. The supply module is adjacent to the operating platform and supplies a film material. The assembly module is used to install the film materials from the supply module to electronic devices. The robotic arm is connected to the assembly module to move the assembly module between the operating platform and the supply module.

### CROSS REFERENCE TO RELATED APPLICATIONS

This application claims priority of China Patent Application No. 202311628995.1, filed on Nov. 30, 2023, the entirety of which is incorporated by reference herein.

### BACKGROUND

### Technical Field

The disclosure relates to an assembly apparatus and method for assembling electronic devices, and in particular to a semi-automatic assembly apparatus and method for assembling electronic devices.

### Description of the Related Art

With the advancements being made in modern technology, large electronic devices have found wider application. Portable electronic devices, such as computers and cell phones in particular, have gradually become indispensable parts of daily life. Part of the assembly process of these electronic devices is still performed manually, making the assembly cost high, and there is still room for improvement in assembly accuracy. As set forth above, how to solve the above challenges is a very important issue.

### BRIEF SUMMARY

The present disclosure provides an assembly apparatus. The assembly apparatus includes an operating platform, a supply module, an assembly module and a robotic arm. The operating platform is used to carry an electronic device. The supply module is adjacent to the operating platform and supplies a film material. The assembly module is used to install the film materials from the supply module to electronic devices. The robotic arm is connected to the assembly module to move the assembly module between the operating platform and the supply module.

The present disclosure provides a method for assembling an electronic device. The method includes placing the electronic device on the transfer tool of an operating platform. The method includes activating the transfer tool to move the electronic device from its initial position to an assembly position. The method includes placing a film material on a supply module. The method includes installing the film material from the supply module to the electronic device using an assembly module. The method also includes moving the electronic device from the assembly position back to the initial position using the transfer tool.

### BRIEF DESCRIPTION OF THE DRAWINGS

The disclosure may be more fully understood by reading the subsequent detailed description and examples with references made to the accompanying drawings, wherein:

FIG. 1 illustrates a top view of the assembly apparatus in accordance with some embodiments of the present disclosure.

FIGS. 2A through 2D illustrate perspective views of various stages of operation of the supply module in accordance with some embodiments of the present disclosure.

FIG. 3 illustrates a partial perspective view of the assembly module in accordance with some embodiments of the present disclosure.

FIG. 4 illustrates a perspective view of the operating platform in accordance with some embodiments of the present disclosure.

FIGS. 5A through 5H illustrate schematic views of various stages of operating assembly apparatus in accordance with some embodiments of the present disclosure.

FIG. 6 illustrates a perspective view of the internal structure of the cleaning tool in accordance with some embodiments of the present disclosure.

### DETAILED DESCRIPTION OF THE INVENTION

The assembly apparatus and method for assembling electronic device of some embodiments of the present disclosure are described in the following description. However, it should be appreciated that the following detailed description of some embodiments of the disclosure provides various concepts of the present disclosure which may be performed in specific backgrounds that may vary widely. The specific embodiments disclosed are provided merely to clearly describe the usage of the present disclosure by some specific methods without limiting the scope of the present disclosure.

In addition, relative terms such as “down” or “bottom,” “up” or “top” may be used in the following embodiments in order to describe the relationship between one element and another element in the figures. It should be appreciated that if the device shown in the figures is flipped upside-down, the element located on the “down” side may become the element located on the “up” side.

It should be understood that although the terms “first,” “second,” etc. may be used herein to describe various elements, materials and/or portions, these elements, materials and/or portions are not limited by the above terms. These terms merely serve to distinguish different elements, materials and/or portions. Therefore, a first element, material and/or portion may be referred to as a second element, material and/or portion without departing from the teaching of some embodiments in the present disclosure. Unless defined otherwise, the first or second element, material and/or portion in the claims may be interpreted as any element, material and/or portion in the specification as long as it conforms to the description in the claims.

Unless defined otherwise, all terms (including technical and scientific terms) used herein have the same meaning as commonly understood by one of ordinary skill in the art to which the present disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined in the present disclosure. In addition, the terms “substantially,” “approximately” or “about” may also be recited in the present disclosure, and these terms are intended to encompass situations or ranges that is substantially or exact the same as the description herein. It should be noted that unless defined specifically, even if the above terms are not recited in the description, it should be read as the same meaning as those approximate terms are recited.

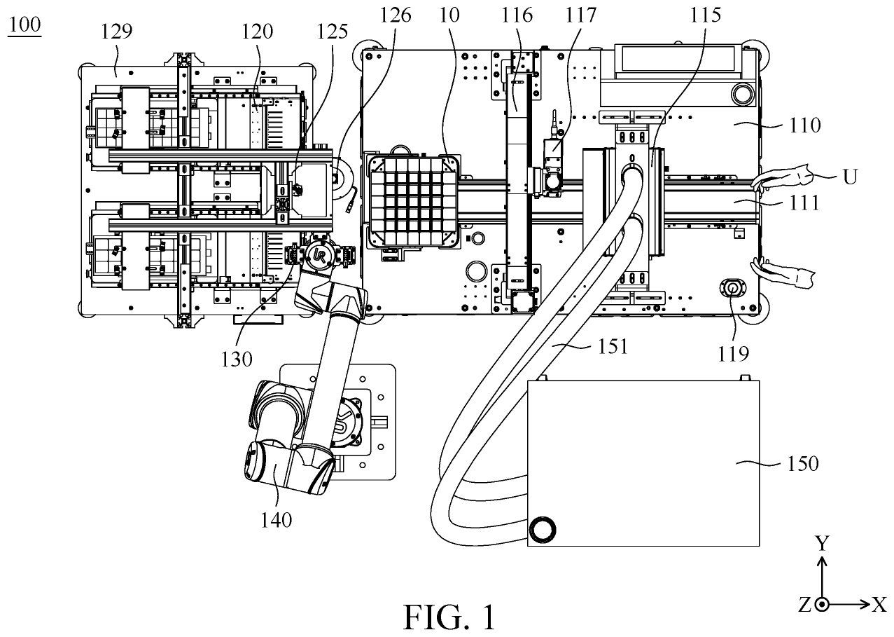

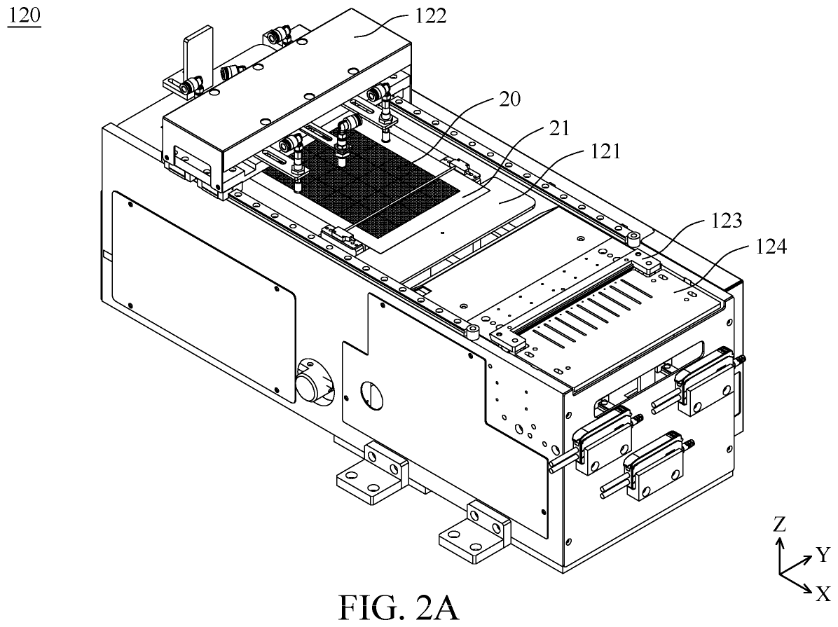

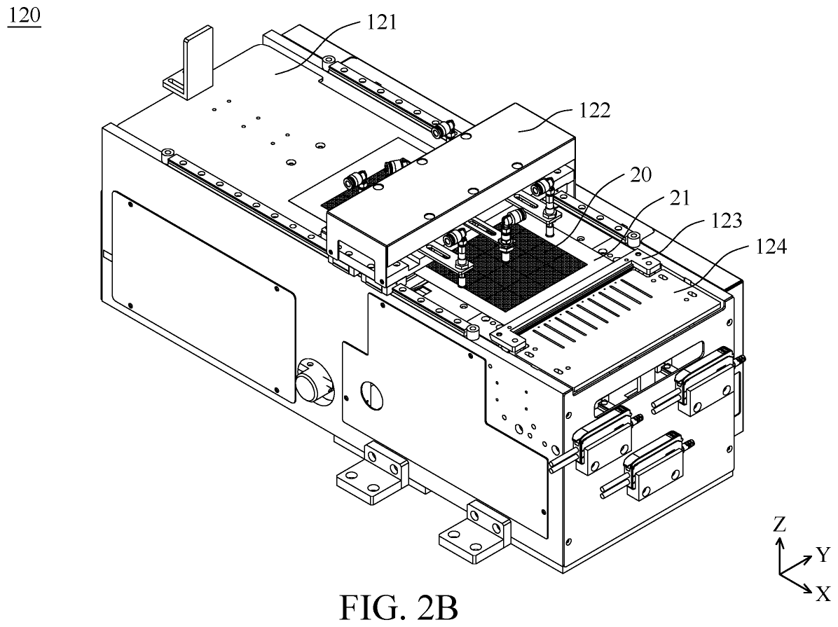

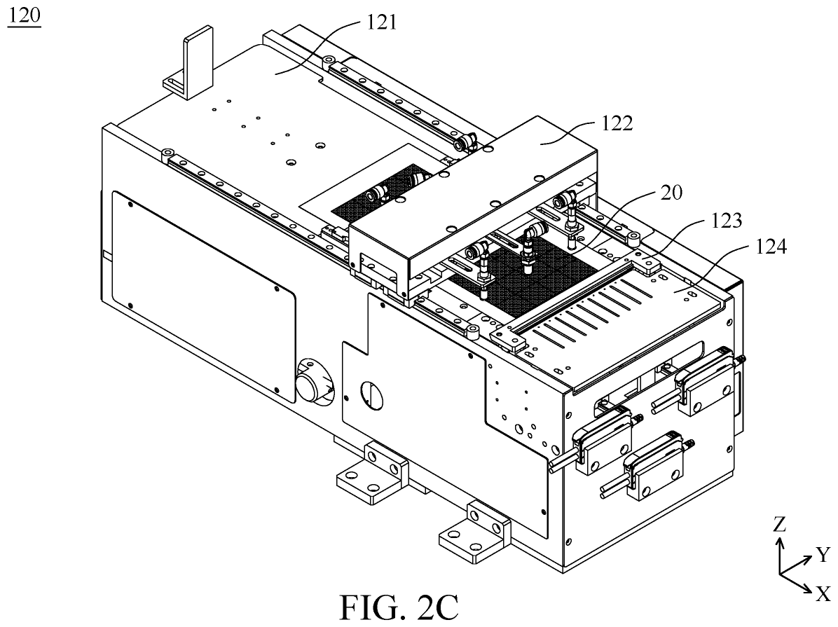

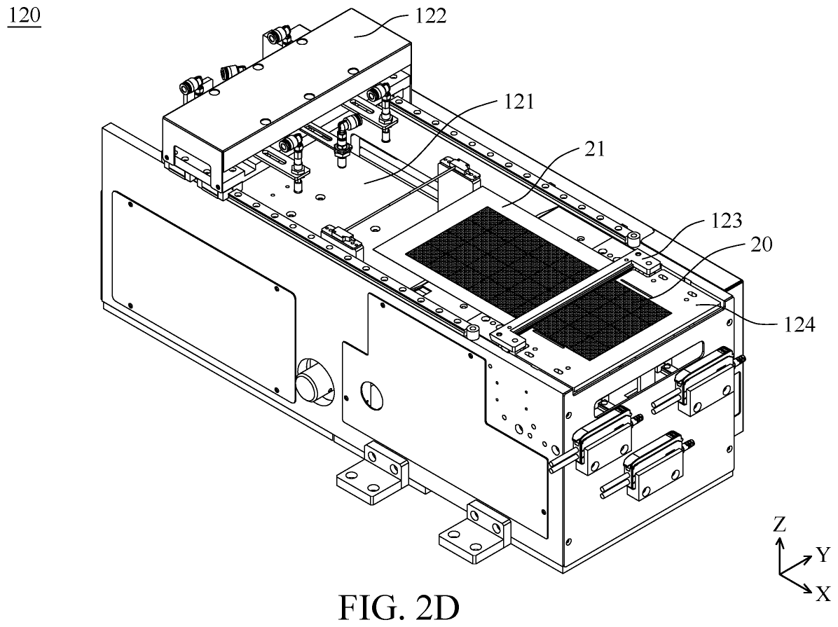

First, referring to FIG. 1, which illustrates a top view of the assembly apparatus 100 in accordance with some embodiments of the present disclosure. It should be noted that the assembly apparatus 100 can be used to assemble the electronic device 10. For example, the film material 20 (shown in FIG. 2A) is installed onto the electronic device 10. As shown in FIG. 1, the assembly apparatus 100 includes an operation platform 110, a supply module 120, an assembly module 130, and a robotic arm 140. The operating platform 110 is used to carry the electronic device 10. In some embodiments, the operating platform 110 includes a transfer tool 111 that can be used to move the electronic device 10 between the initial position (a position adjacent to the user U, for example) and the assembly position (a position adjacent to the supply module 120, for example). In some embodiments, the assembly position is closer to the robotic arm 140 than the initial position.

In some embodiments, the operating platform 110 includes a cleaning tool 115 that is disposed between the above-mentioned initial position and the assembly position. The assembly apparatus 100 may further include an air extraction apparatus 150 that communicates with the cleaning tool 115 via a tube 151 for cleaning the electronic device 10 (for example, removing dust or static electricity on the electronic device 10 to improve the yield of subsequent assembly of the electronic device 10). In some embodiments, the operating platform 110 includes a bracket 116 that is disposed above the transfer tool 111 and a detection tool 117 that is connected to the bracket 116 and movable along the bracket 116.

In addition, in some embodiments, the supply module 120 is adjacent to the operating platform 110 and may supply the film material 20. In some embodiments, at least one supply module 120 (for example, two feeding modules 120 are shown in this embodiment, but the present disclosure is not limited thereto) may be disposed on the supply platform 129. In some embodiments, the supply module 120 includes an upper sensor 125 and a lower sensor 126. To be more specific, the upper sensor 125 can detect the supply status of the film material 20 on the supply module 120, and the lower sensor 126 can detect the film material 20 which is picked up by the assembly module 130. For example, the upper sensor 125 and the lower sensor 126 may be visual sensors, but the present disclosure is not limited thereto. The details of the supply module 120 supplying the film material 20 will be further described below with reference to FIGS. 2A through 2D. It should be understood that the film material 20 may encompass any suitable material with any shape. For example, the film material 20 can be a label to subsequently help to identify the information on the electronic device 10. In other embodiments, the film material 20 may be a material with high thermal conductivity to help to improve the heat dissipation capability of the electronic device 10. However, the present disclosure is not limited thereto.

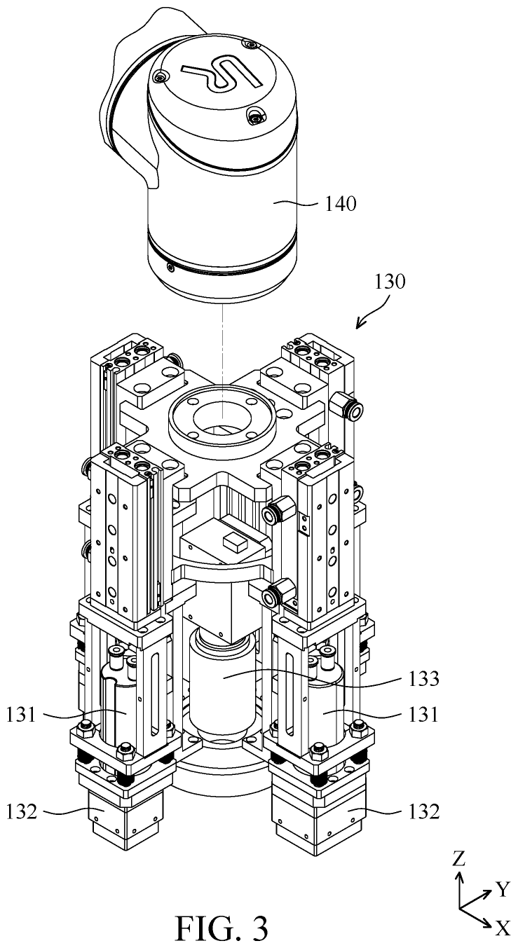

In some embodiments, the assembly module 130 is used to install the film material 20 from the supply module 120 onto the electronic device 10. The detailed structure of the assembly module 130 will be further described below with reference to FIG. 3. In some embodiments, the robotic arm 140 is connected to the assembly module 130 to move the assembly module 130 between the operating platform 110 and the supply module 120. In this way, a semi-automated assembly process can be achieved to replace the original manual assembly process, thereby reducing costs and improving assembly accuracy.

FIGS. 2A through 2D illustrate perspective views of various stages of operation of the supply module 120 in accordance with some embodiments of the present disclosure. In some embodiments, the supply module 120 includes a lifting platform 121, a pick-up mechanism 122, a film-pressing mechanism 123 and a discharging platform 124. The lifting platform 121 is movable in a vertical direction (for example, parallel to the Z-axis), and the film material 20 may be placed on the lifting platform 121. For example, a release layer 21 may be provided on one side of the film material 20 to facilitate storage or protection of the film material 20, but the present disclosure is not limited thereto. The pick-up mechanism 122 can pick up the film material 20 on the lifting platform 121. The film-pressing mechanism 123 can separate the film material 20 from the release layer 21, and the separated film material 20 will be transported to the discharging platform 124.

As shown in FIG. 2A, at this stage, the lifting platform 121 rises (that is, moves in the vertical direction) and transports the film material 20 (including the release layer 21) toward the pick-up mechanism 122. Next, as shown in FIG. 2B, the pick-up mechanism 122 and the supply mechanism (not shown) inside the supply module 120 can move the film material 20 (including the release layer 21) toward the film-pressing mechanism 123 in the horizontal direction (for example, parallel to the Y-axis). Next, as shown in FIG. 2C, the film-pressing mechanism 123 can be pressed down to transport the release layer 21 to the film-clamping mechanism (not shown) inside the supply module 120, so that the release layer 21 and the film material 20 are separated. Finally, as shown in FIG. 2D, the separated film material 20 will be transported to the discharging platform 124. At the same time, the lifting platform 121 descends to receive new film material 20, thereby repeating the above steps of supplying the film material 20.

FIG. 3 illustrates a partial perspective view of the assembly module 130 in accordance with some embodiments of the present disclosure. As shown in FIG. 3, the assembly module 130 may include a plurality of cylinder members 131, a plurality of vacuum suction heads 132 and a sensor 133. The cylinder members 131 are movable in the vertical direction (for example, parallel to the Z-axis). The vacuum suction heads 132 are each connected to a corresponding cylinder member 131. As a result, the vacuum suction heads 132 can suck the film material 20 on the discharge platform 124, and the cylinder member 131 can exert force to install the film material 20 on the electronic device 10. In some embodiments, the sensor 133 may be disposed between the vacuum suction heads 132 to facilitate positioning the film material 20 to a corresponding area on the electronic device 10. For example, the sensor 133 may be a visual sensor for detecting the actual condition of the supplied film material 20 (for example, whether the film material 20 is damaged, or whether the supplied film material 20 conforms to the electronic device 10, etc.). However, the present disclosure is not limited thereto. Since the assembly module 130 includes multiple cylinder members 131 and vacuum suction heads 132, and is connected to a movable and rotating robotic arm 140, the time required to assemble the film material 20 onto the electronic device 10 can be effectively shortened.

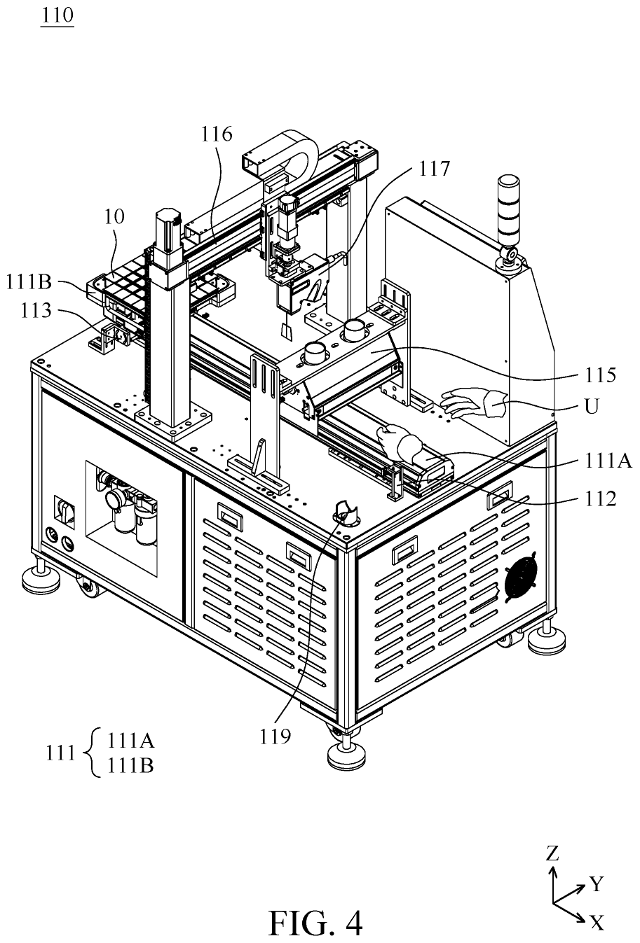

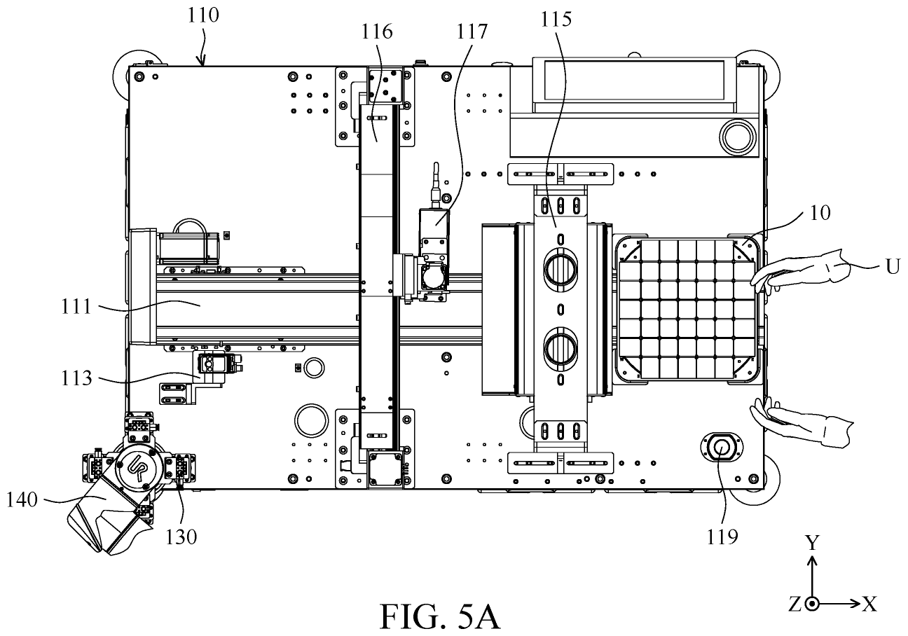

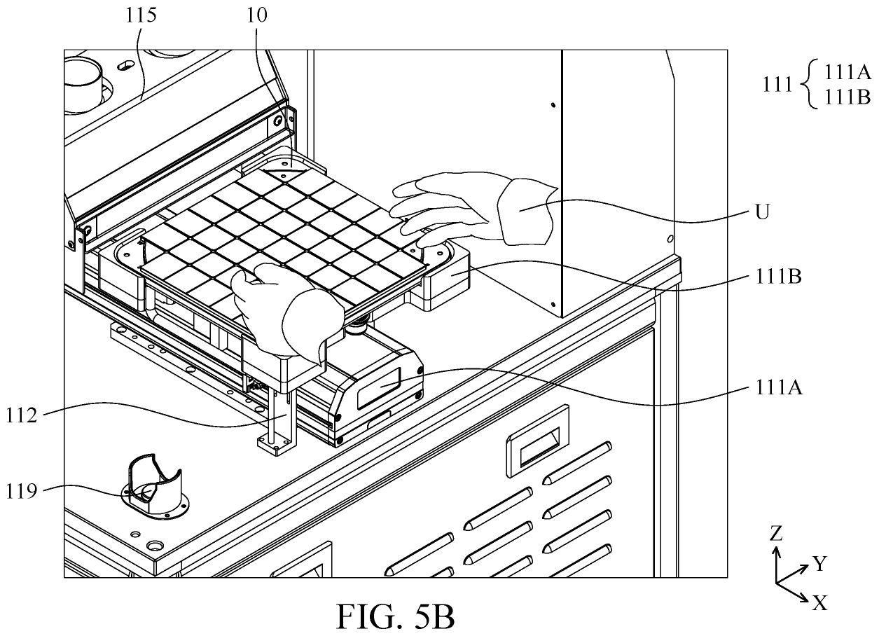

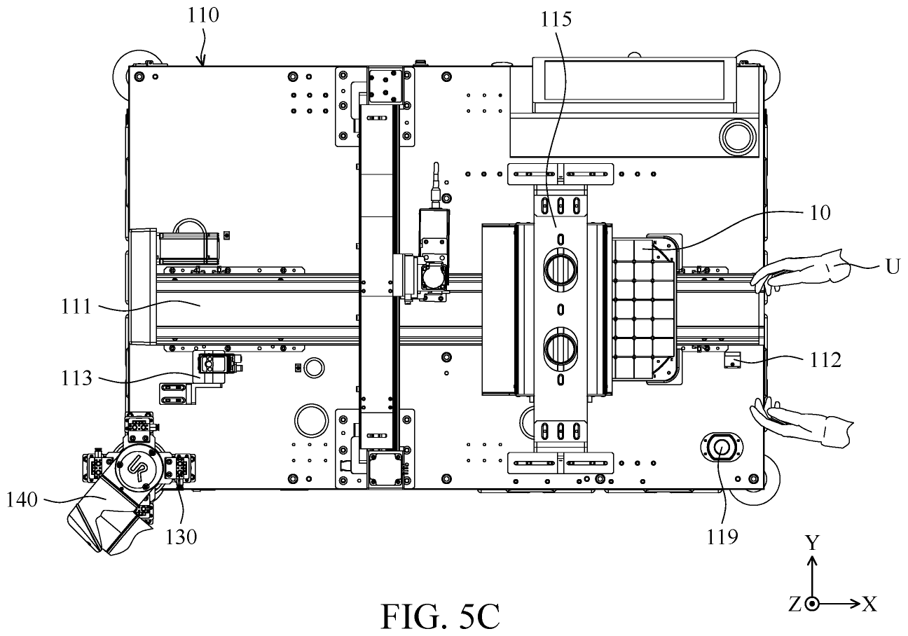

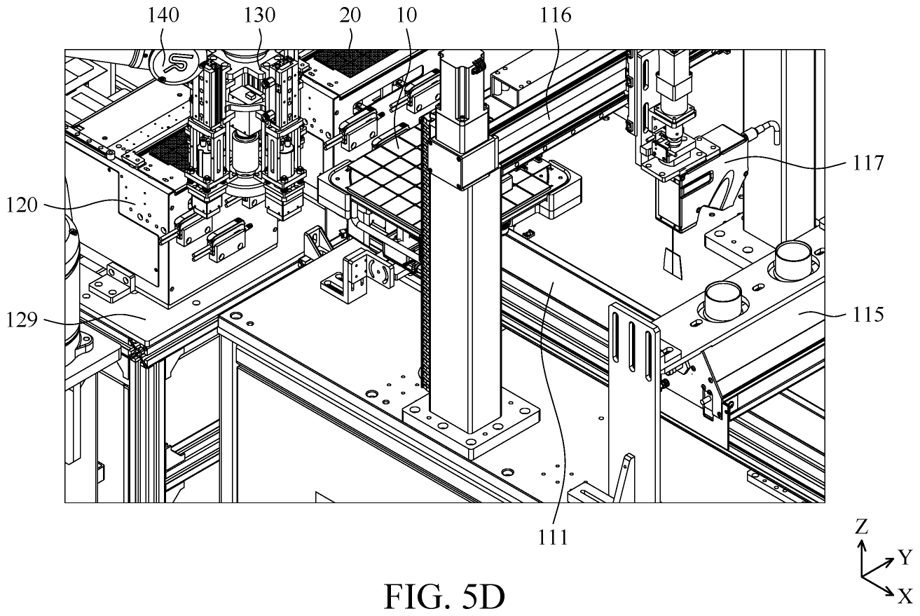

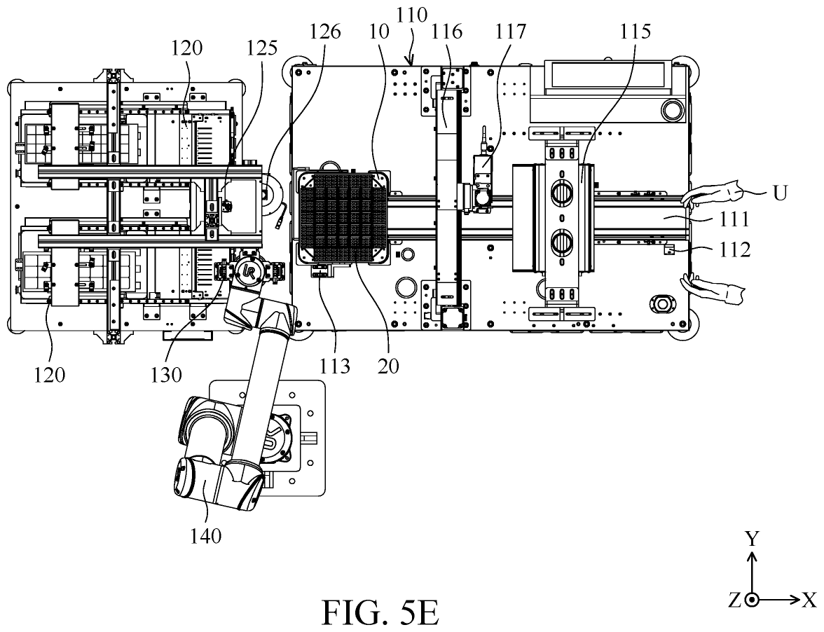

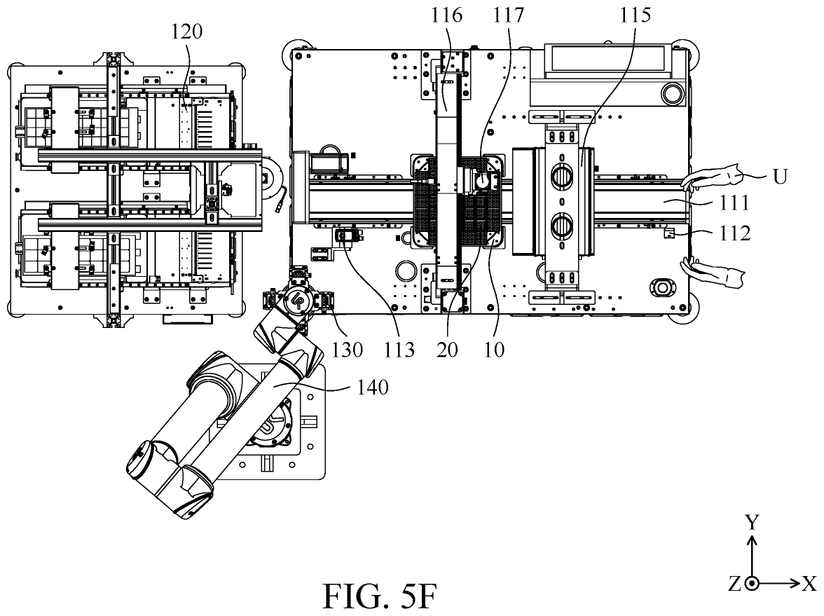

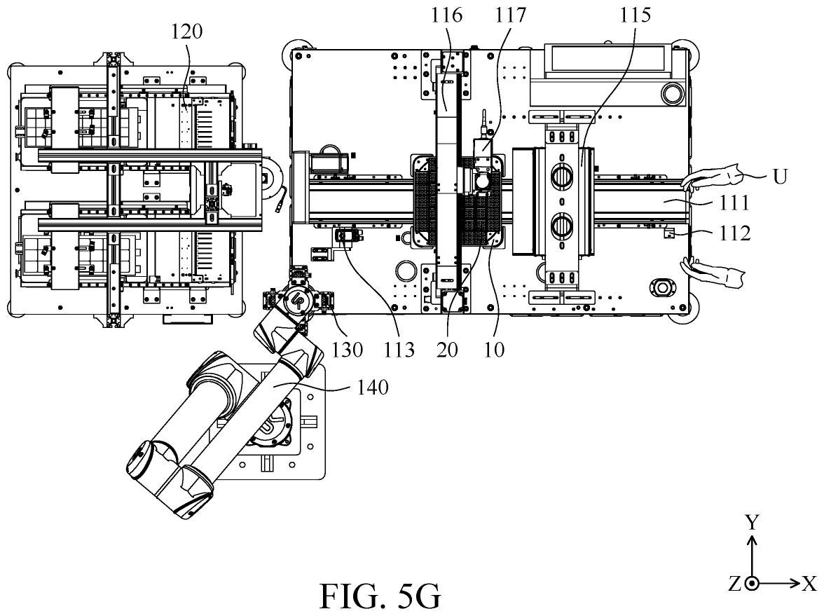

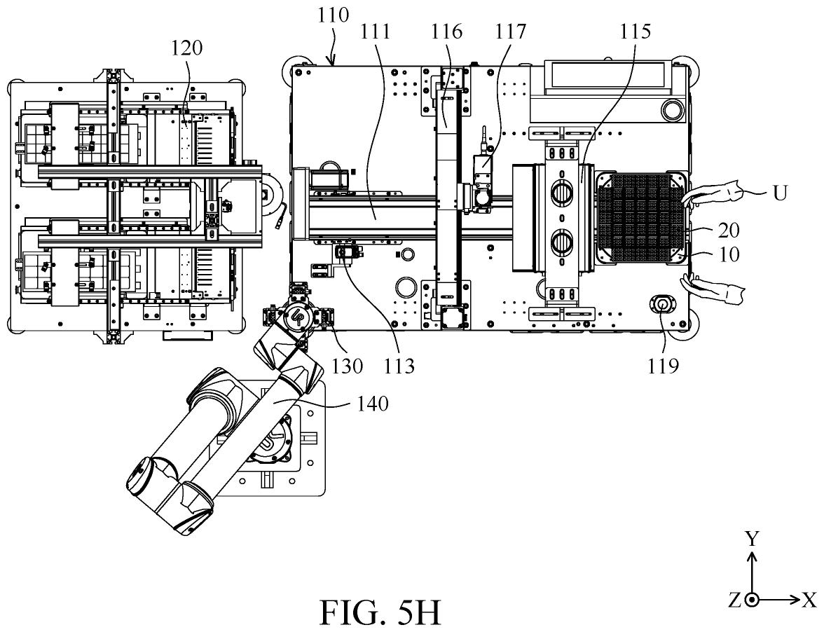

FIG. 4 illustrates a perspective view of the operating platform 110 in accordance with some embodiments of the present disclosure. As shown in FIG. 4, the transfer tool 111 may include a track 111A and a carrier 111B. The user U can place the electronic device 10 to be assembled on the carrier 111B, and the carrier 111B is movable along the track 111A to move the electronic device 10 between the initial position (such as a position adjacent to the user U) and the assembly position (such as a position adjacent to the supply module 120). In some embodiments, the operating platform 110 includes a sensor 112, which is disposed in the above-mentioned initial position and is used to sense whether the electronic device 10 is located in the initial position. In some embodiments, the operation platform 110 includes a code reader 113, which is disposed at the above-mentioned assembly position and is used to read barcodes (not shown) on the electronic device 10. The detailed operation of each component on the operating platform 110 will be further described below with reference to FIGS. 5A through 5H.

FIGS. 5A through 5H illustrate schematic views of various stages of operating the assembly apparatus 100 according to some embodiments of the present disclosure. As shown in FIG. 5A, the user U can place the electronic device 10 to be assembled on the transfer tool 111 (such as the carrier 111B) of the operating platform 110 and press the start button 119 to activate the transfer tool 111 to perform the assembly process. As shown in FIG. 5B, the sensor 112 on the operating platform 110 can detect the position of the electronic device 10. Therefore, it is can be determined whether the electronic device 10 has been placed on the transfer tool 111 (such as the carrier 111B), so as to reduce the risk that the user U accidentally touches the start button 119. In some other embodiments, if the sensor 112 detects that the electronic device 10 has been placed on the transfer tool 111 (such as the carrier 111B), the assembly process is automatically initiated. In this way, the start button 119 may be omitted to further simplify the assembly process.

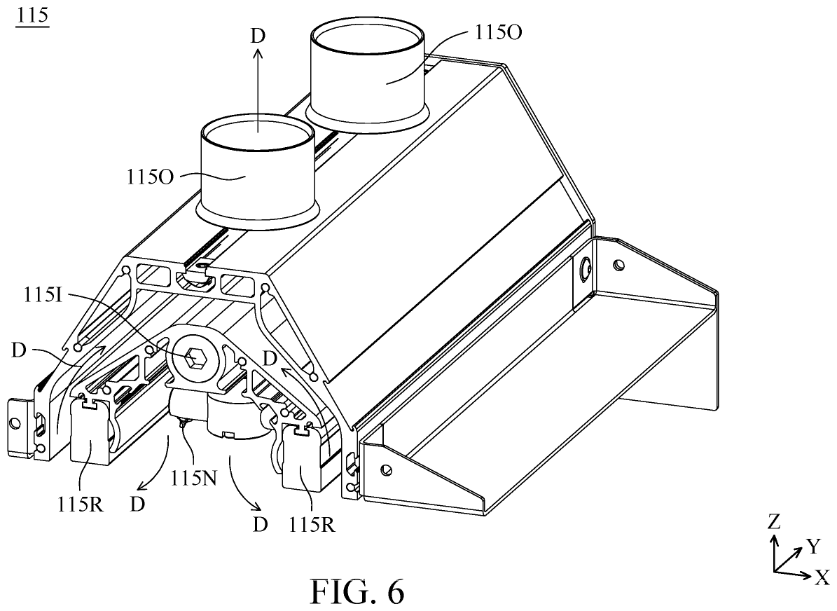

As shown in FIG. 5C, the transfer tool 111 moves the electronic device 10 below the cleaning tool 115, and the cleaning tool 115 cleans the electronic device 10 (for example, removes dust or static electricity on the electronic device 10) to improve yield of the electronic device 10 assembled subsequently. The detailed structure and operation of the cleaning tool 115 will be further described below with reference to FIG. 6. Next, as shown in FIG. 5D, the transfer tool 111 moves the electronic device 10 to the assembly position that is adjacent to the supply module 120. For example, the barcode (not shown) on the electronic device 10 can be read by the code reader 113 that is disposed at the assembly position to determine whether it is the electronic device 10 to be assembled and/or to confirm the position where the film material 20 is installed.

Next, as shown in FIG. 5E, the robotic arm 140 drives the assembly module 130 to suck the film material 20 on the supply module 120, and then install the film material 20 from the supply module 120 onto the electronic device 10. In some embodiments, the film material 20 can be placed on the supply module 120, for example, referring to the processes shown in FIG. 2A through FIG. 2D. In some embodiments, the upper sensor 125 can detect the supply status of the film material 20 on the supply module 120, and the lower sensor 126 can detect the film material 20 picked-up of by the assembly module 130. If the upper sensor 125 or the lower sensor 126 detects an abnormal condition (for example, the film material 20 is damaged), the assembly apparatus 100 will issue a warning to notify the user to rule out the abnormal condition.

Next, as shown in FIG. 5F, the transfer tool 111 moves the electronic device 10 installed with the film material 20 to a position under the detection tool 117 so as to detect whether the film material 20 on the electronic device 10 is well installed and positioned. For example, the detection tool 117 may be a laser detector, but the present disclosure is not limited thereto. The detection tool 117 is movable along the bracket 116 and rotatable relative to the bracket 116 (for example, rotated 90°, as shown in FIG. 5G). In this way, the detection tool 117 can detect the position of the film material 20 installed on the electronic device 10 in two-dimensional directions. Finally, as shown in FIG. 5H, the transfer tool 111 moves the electronic device 10 installed with the film material 20 back to the initial position, and the user U can retrieve the assembled electronic device 10.

FIG. 6 illustrates a perspective view of the internal structure of the cleaning tool 115 in accordance with some embodiments of the present disclosure. As shown in FIG. 6, the cleaning tool 115 includes an air inlet 115I, an air outlet 1150, a plurality of ion rods 115R and a plurality of nozzles 115N. The nozzles 115N are used to spray the airflow from the air inlet 115I toward the electronic device 10 (as shown in the direction D) and rotatable relative to the electronic device 10. Dust or other impurities on the electronic device 10 can thereby be removed. Then, the airflow described above may pass through the ion rod 115R. Specifically, the ion rod 115R can release static electricity to neutralize the static electricity on the electronic device 10 and absorb dust and impurities brought by the airflow. After the dust and impurities pass through the ion rod 115R, the airflow can leave the cleaning tool 115 (as shown in direction D) through the air outlet 1150 (for example, communicating with the air extraction apparatus 150, referring to FIG. 1). In this way, dust and impurities between the electronic device 10 and the film material 20 can be reduced, thereby improving the yield of the electronic device 10.

As set forth above, the present disclosure provides a semi-automatic assembly apparatus and a method for assembling electronic devices. The use of robotic arms and assembly modules to install film materials onto electronic devices replaces the original manual process, thereby reducing manufacturing costs and improving assembly accuracy. In addition, the assembly apparatus of the present disclosure is also equipped with detection tools and multiple sensors, which helps to reduce the risk of assembly errors and improve the yield of the electronic devices.

While the embodiments and the advantages of the present disclosure have been described above, it should be understood that those skilled in the art may make various changes, substitutions, and alterations to the present disclosure without departing from the spirit and scope of the present disclosure. In addition, the scope of the present disclosure is not limited to the processes, machines, manufacture, composition, devices, methods and steps in the specific embodiments described in the specification. Those skilled in the art may understand existing or developing processes, machines, manufacture, compositions, devices, methods and steps from some embodiments of the present disclosure. As long as those may perform substantially the same function in the aforementioned embodiments and obtain substantially the same result, they may be used in accordance with some embodiments of the present disclosure. Therefore, the scope of the present disclosure includes the aforementioned processes, machines, manufacture, composition, devices, methods, and steps. Furthermore, each of the appended claims constructs an individual embodiment, and the scope of the present disclosure also includes every combination of the appended claims and embodiments.

What is claimed is:

1. An assembly apparatus, comprising:
an operating platform used to carry an electronic device;
a supply module adjacent to the operating platform and supplying a film material;
an assembly module used to install the film material from the supply module onto the electronic device; and
a robotic arm connected to the assembly module to move the assembly module between the operating platform and the supply module.

2. The assembly apparatus as claimed in claim 1, wherein the operating platform comprises a transfer tool used to move the electronic device between an initial position and an assembly position, and the assembly position is closer to the robotic arm than the initial position.

3. The assembly apparatus as claimed in claim 2, wherein the operating platform comprises a sensor disposed at the initial position and used to detect whether the electronic device is located at the initial position.

4. The assembly apparatus as claimed in claim 2, wherein the operating platform includes a code reader disposed at the assembly position and used to read a bar code on the electronic device.

5. The assembly apparatus as claimed in claim 2, wherein the operating platform comprises a cleaning tool disposed between the initial position and the assembly position.

6. The assembly apparatus as claimed in claim 5, wherein the cleaning tool comprises a nozzle, and the nozzle is used to spray airflow toward the electronic device and is rotatable relative to the electronic device.

7. The assembly apparatus as claimed in claim 5, further comprising an air extraction apparatus communicating with the cleaning tool via a tube.

8. The assembly apparatus as claimed in claim 5, wherein the cleaning tool comprises an ion rod.

9. The assembly apparatus as claimed in claim 2, wherein the operating platform comprises:
a bracket disposed over the transfer tool; and
a detection tool connected to the bracket and movable along the bracket.

10. The assembly apparatus as claimed in claim 9, wherein the detection tool is rotatable relative to the bracket.

11. The assembly apparatus as claimed in claim 2, wherein the operation platform has a start button used to activate the transfer tool.

12. The assembly apparatus as claimed in claim 1, wherein the supply module comprises a lifting platform and a pick-up mechanism, wherein the lifting platform is movable in a vertical direction and used to provide the film material for the pick-up mechanism.

13. The assembly apparatus as claimed in claim 1, wherein the supply module further comprises a film-pressing mechanism used to release the film material from a release layer.

14. The assembly apparatus as claimed in claim 1, wherein the assembly module comprises:
a plurality of cylinder members movable in a vertical direction; and
a plurality of vacuum suction heads each connected to a corresponding cylinder member.

15. The assembly apparatus as claimed in claim 14, wherein the assembly module comprises a sensor disposed between the vacuum suction heads.

16. A method for assembling an electronic device, comprising:
placing the electronic device on a transfer tool of an operating platform;
activating the transfer tool to move the electronic device from an initial position to an assembly position;
placing a film material on a supply module;
installing the film material from the supply module to the electronic device using an assembly module; and
moving the electronic device from the assembly position back to the initial position using the transfer tool.

17. The method as claimed in claim 16, further comprising:
using a cleaning tool to clean the electronic device.

18. The method as claimed in claim 16, further comprising:
detecting the film material using a plurality of sensors of the supply module.

19. The method as claimed in claim 16, further comprising:
using a detection tool to detect a position where the film material is installed on the electronic device.

20. The method as claimed in claim 16, wherein activating the transfer tool comprises:
pressing a start button on the operating platform; and
detecting a position of the electronic device using a sensor on the operating platform.
